(19) United States
(12) Patent Application Publication
(10) Pub. No.: US 2008/0238286 A1
(43) Pub. Date: Oct. 2, 2008

(54) Crt Having a Low Moire Transformation Function

(76) Inventor: Robert Lloyd Barbin, Henderson, NV (US)

Correspondence Address: Joseph J. Laks;Thomson Licensing LLC, 2 Independence Way, Patent Operations, PO Box 5312, PRINCETON, NJ, 08543, US

(21) Appl. No.: 10/586,708

(22) PCT Filed: Jan. 23, 2004
(86) PCT No.: PCT/US2004/001930

§ 371 Date: Jul. 20, 2006

(51) Int. Cl. H01J 1/62; H01J 29/46

(52) U.S. Cl. 313/441; 313/486

(57) ABSTRACT

The CRT (10) according to the invention has an envelop (11) including a panel (12) attached to a funnel (15), the funnel having a neck (14) and an electron gun (26) for generating at least one electron beam (28) contained in the neck. A mask (25) is contained in the envelop near the panel. A region of the mask has columns (30) of apertures (31) of predetermined heights and predetermined pitches. The at least one electron beam has a spot size range and spot shape selected such that the moiré transformation function for the CRT in the region is less than about 0.02, wherein the moiré transformation function is a quotient having a numerator being the difference between a maximum value and a minimum value of mask transmission and a denominator being the sum of the maximum and the minimum values. The mask transmission is the percentage of electrons of a spatially uniform electron beam incident on the mask that can propagate therethrough the apertures averaged over a plurality of adjacent mask aperture columns and the regions containing the maximum and minimum values are adjacent to each other.

### FIELD OF THE INVENTION

The invention relates to a color cathode-ray tube (CRT) and, more particularly to a color CRT having a reduced propensity for visible moiré over a plurality scan line modes.

### BACKGROUND OF THE INVENTION

The current trend in the television industry is to provide displays to consumers which have clear crisp images with high resolution. As such, the television industry is challenged to broadcast and transmit signals which are digital and have high definition. Further, the industry is challenged to manufacture display devices, including those with the cathode ray tube (CRT), which can receive and display high definition digital signals and display such corresponding images in high resolution.

Regarding CRTs, to provide the end user with higher resolution images (i.e. images having increasingly more and smaller screen structure elements), CRT designers and manufacturers are also challenged to produce CRTs with electron beam spot sizes that are increasingly smaller. It is well understood by those in the CRT industry that as the resolution increases, the manufacture of CRTs become inherently more difficult.

The CRT designers and manufactures are even further challenged by the fact that as the television industry progresses toward higher resolution displays and HDTV (high definition television), the number of scan mode types (correlating to the number of scan lines) have proliferated. FIG. 1 shows a plot of some various scan modes that have been used or considered. The width at each of these scan mode types is associated with variations in the amount of overscan (i.e. the greater the overscan the lower the number of scan lines on the viewable screen and the lesser the overscan the greater the number of scan lines on the viewable screen). The difficulty is that the modern day and future CRT designs may be expected to accommodate certain desired resolutions at many different scan modes. However, CRTs (as shown in FIG. 2), when used to accommodate a variety of scan line modes, unfortunately may exhibit undesirable moiré at some of these scan modes.

Moiré is a vertical repeat pattern (or otherwise known as a beat pattern of at least two functions, one on top of another). The pattern is displayed as alternating light and dark stripes which are approximately horizontal when a raster of scan lines, having peak intensity regions and lesser intensity regions and having a scan line spacing, propagate on and through a mask having cyclical horizontal transmission bands. The vertical repeat pattern is characterized by having some pitch and some contrast between the alternating horizontal light and dark stripes. The moiré becomes perceptible to the human eye when the contrast between the alternating light and dark stripes exceeds a certain threshold value associated with a particular moirépitch value that is within a finite range of moiré pitch values that are possibly perceptible to the human eye (i.e. pitch values which are too large or too small will not be detectable regardless of the contrast). FIG. 3 shows an enlarged section of a mask 25, having individual columns 30 of mask apertures 31, which are separated by tie bars 32, wherein A_{V} is the column aperture pitch and w is the height of the tie bars. FIG. 4 shows an example of the horizontal transmission bands, where the higher transmission bands are designated as HT and the lesser transmission bands are designated as LT. As shown in FIG. 4, the horizontal transmission bands of the mask are created by the tie bar arrangement in a shadow mask. Typically the vertical repeat pattern of the mask is chosen such that the CRT is never operated near a moiré zero beat condition. A better understanding of moiré can be gained with reference to FIGS. 5-7, wherein the mask has a mask transmission profile MTP with higher transmission bands HT and lesser transmission bands LT, and a column aperture pitch Aᵥ. FIG. 5 shows the CRT at an intensity maximum condition. FIG. 5 shows the scan line positions SLP, the collective electron beam intensity profile EBP and scan line spacing S_{L}. (The collective electron beam intensity profile EBP is a composite of the multiple scan lines as if they were simultaneous.) The conditions represented in FIG. 5 are considered a zero beat condition because the mask transmission profile MTP and the electron beam intensity profile EBP are in phase and have the same wavelength. In other words, the phase between the scan lines and the mask pattern is such that the maximum number of electrons are passed through the mask. This may appear to be an ideal condition where no moiré would be observed (because theoretically the moiré pitch approaches infinity); however, this is actually not desired because when a CRT is designed to operate in such a manor, it is extremely difficult, if not impossible, to have the electron beam profiles (or scan line positions) not deviate from the mask transmission profile. Unfortunately, in practice when a CRT is designed to operate as that in FIG. 5, the deviation of electron beam profiles (or scan line positions) with respect to the mask transmission profile becomes visible to a viewer. This can be seen with reference to FIG. 6, which shows the same CRT as in FIG. 5; however, the region shown is at an intensity minimum condition, where there is substantially less brightness compared to the condition in FIG. 5 due to a change in the phase between the electron beam intensity profile EBP and the mask transmission profile MTP. The conditions in FIG. 5 and FIG. 6 are an example of the range of brightness an observer can see on the same screen when a CRT is made to operate near a zero beat mode. As such, the CRT manufacturer typically designs a tube to not operate near a zero beat mode. FIG. 7 shows another type of CRT design where the mask transmission profile MTP and the electron beam intensity profile EBP deviate slightly from one another. In this case, light moiré bands LMB, which are locations where higher transmission band HT regions of the mask are nearly in phase with the maxima of the electron beam intensity profile EBP, and dark moiré bands DMB, which are regions where the higher transmission band HT regions of the mask are nearly in phase with the minima of the electron beam intensity profile EBP, are close together. The moiré of this tube in FIG. 7 may become detectable depending on the difference in brightness between the light moiré bands LMB and dark moiré bands DMB and the actual moiré pitch value P (i.e., depending on whether the pitch value is in a regime detectable to the human eye).

What has also been problematic in CRTs having increased resolution is the effect of self-convergence that takes place when the electron beams are deflected by the horizontal deflection field of self-converging systems. This produces a lensing effect on the deflected beams that causes them to be overfocused in the vertical direction at 3:00 and 9:00 screen edges. When this overfocus is corrected with a dynamic focus gun, the resultant spot size in the vertical direction is much smaller at these 3:00 and 9:00 edges than in the center of the screen. This small vertical spot increases the maximum to minimum amplitude of the electron beam intensity profile EBP, which sometimes causes visible moiré near the 3:00 and 9:00 edges of the screen, while at the same time other areas exhibit no moiré. The amount of dynamic focus correction can be decreased to reduce or eliminate this moiré, but this increases the spot size and reduces the resolution.

Hence, there is a need for a novel CRT design which can produce CRTs with no objectionable moiré at a variety of scan modes.

### SUMMARY OF THE INVENTION

The invention is a cathode ray tube (CRT) comprising an envelope having a panel and funnel. The panel includes a faceplate having a luminescent screen thereon with the screen comprising a plurality of phosphor stripes. The panel further includes a mask contained therein, wherein the mask has a plurality of columns of apertures. Each column corresponds to a respective set of phosphor stripes and each column includes tie bars which separate adjacent intra-column apertures from each other. The CRT is further characterized by the funnel having a neck at an end opposite of the panel, wherein the neck contains an electron gun. The gun emits at least one electron beam which scans across the columns of the mask in a direction perpendicular to the stripes. Portions of the electron beam propagate through the apertures and impinge corresponding phosphor stripes. At least one electron beam scans across the screen in a predetermined pattern that includes a number of sweeps which constitute a scan line mode and makes up a full screen frame. Adjacent sweeps each have a pixel pitch (or scan line spacing). In one embodiment of the invention, at least one of electron beams has a spot size, which varies as a function of location of the electron beam on the screen as the beam scans, wherein the ratio of the spot size of the electron beam to the intra-column mask aperture pitch exceeds about 0.9 and the aperture pitch decreases with increasing distance from a central aperture column over at least one lateral portion across said screen, thereby reducing perceptible moiré. The spot size is the full vertical width of that portion of a single electron beam that exceeds 5% of the peak electron beam intensity.

Other features of the invention include the CRT having a moiré transformation function of less than about 0.02. The moiré transformation function is a quotient having a numerator being the difference between the electron beam transmission maximum value and the electron beam transmission minimum value and a denominator being the sum of the electron beam transmission maximum value and the electron beam transmission minimum value. The electron beam transmission values are an integrated value and are a function of phase between the mask structures and scan lines with the electron beam having a uniform intensity before transmitting through the mask. The moiré can be controlled by appropriately selecting electron beam spot size and shape, intra-column mask aperture pitch and mask tie bar height such that the moiré transformation function does not exceed 0.02.

### BRIEF DESCRIPTION OF THE DRAWINGS

The invention will now be described in greater detail, with relation to the accompanying drawings, in which:

FIG. 1 shows a plot of some various scan modes;

FIG. 2 is a plan view, partly in axial section, of a color cathode-ray tube (CRT);

FIG. 3 is an enlarged section of a mask of a CRT;

FIG. 4 is an enlarged section of a mask with the horizontal transmission bands shown;

FIG. 5 is a plot showing the spacial relationship of the electron beam profile of adjacent electron beam scans with respect to the horizontal transmission bands of a mask at a moiré zero beat condition at an intensity maximum phase;

FIG. 6 is a plot showing the spacial relationship of the electron beam profile of adjacent electron beam scans with respect to the horizontal transmission bands of a mask at a moiré zero beat condition at an intensity minimum phase;

FIG. 7 is a plot showing the spacial relationship of the electron beam profile of adjacent electron beam scans with respect to the horizontal transmission bands of a mask at a non-moiré null condition;

FIG. 8 shows the CRT of FIG. 2 having the electron beams propagating through a single mask aperture and onto the screen and further shows the electron beam intensity profile of the beam prior to propagating through the mask aperture;

FIG. 9 shows moiré pitch and moiré visibility plotted with respect to the number of scan lines;

FIG. 10 is plot showing the moiré transformation function versus electron beam spot size to intra-column mask aperture pitch for a Gaussian-shaped electron beam;

FIG. 11 is a plot showing the moiré transformation function versus electron beam spot size to intra-column mask aperture pitch for a rectangular-shaped electron beam; and

FIG. 12 is a mask according to an embodiment of the invention with an enlarged section portion.

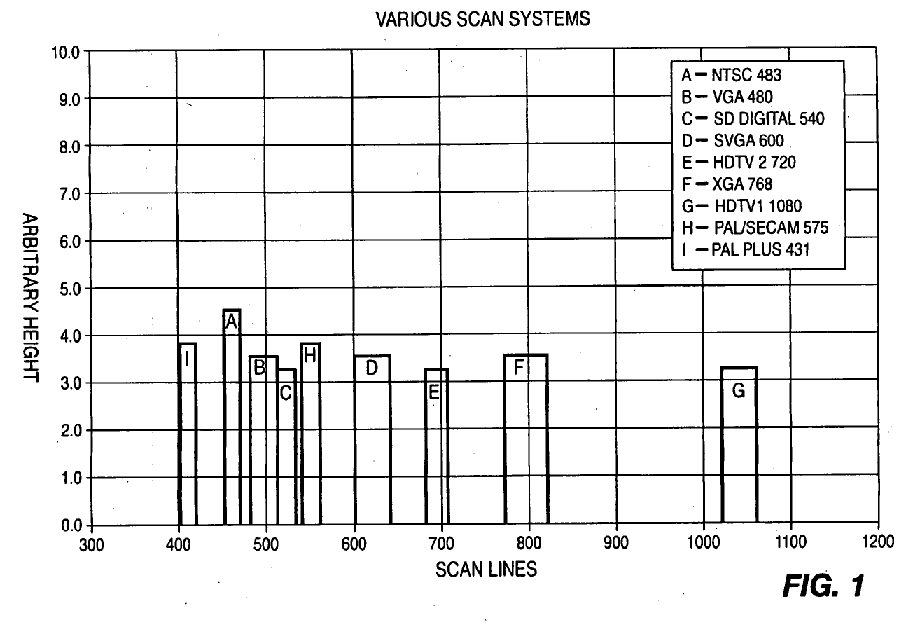

### DETAILED DESCRIPTION OF THE PREFERRED EMBODIMENT

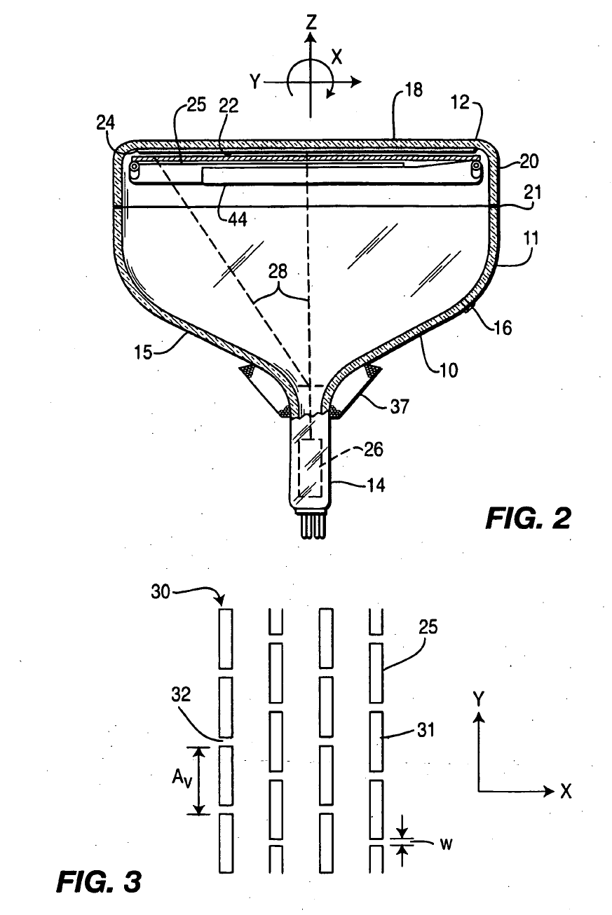

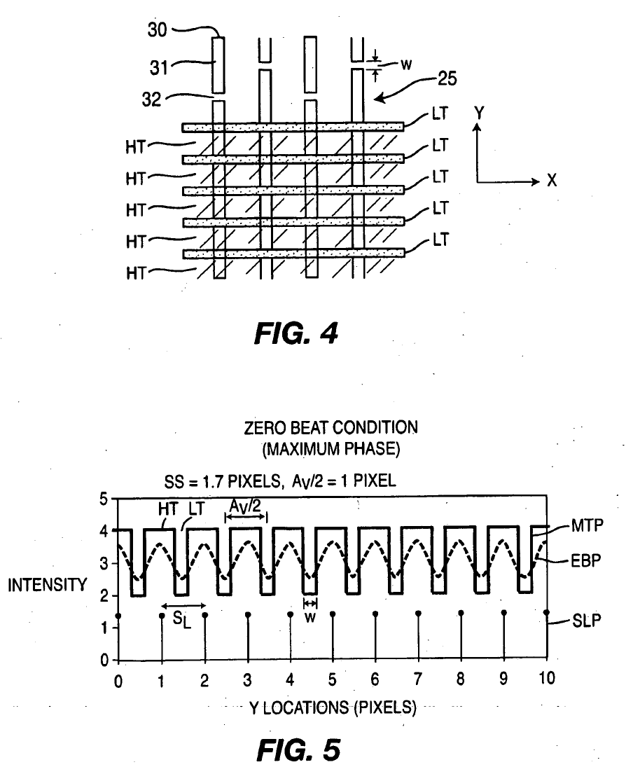

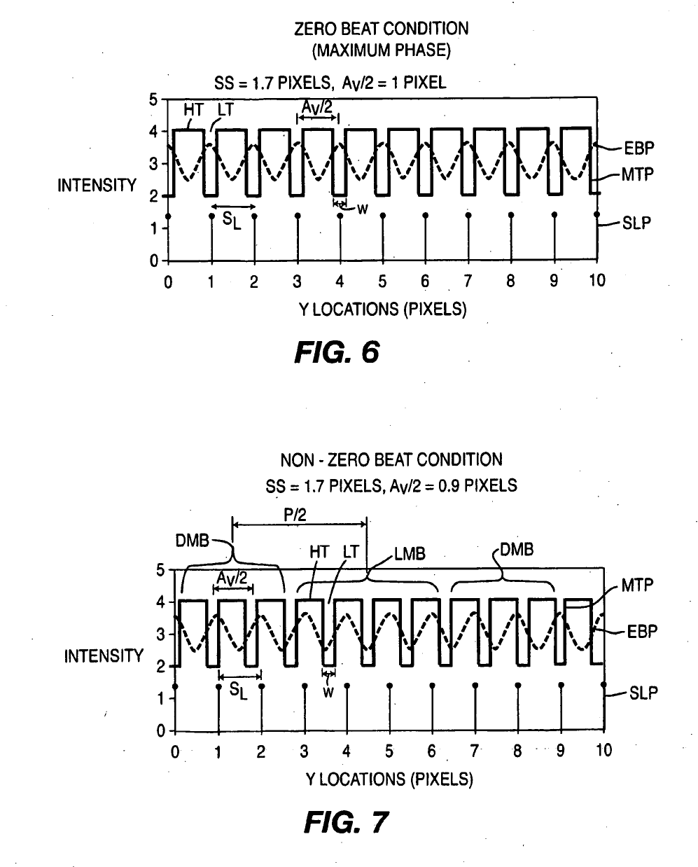

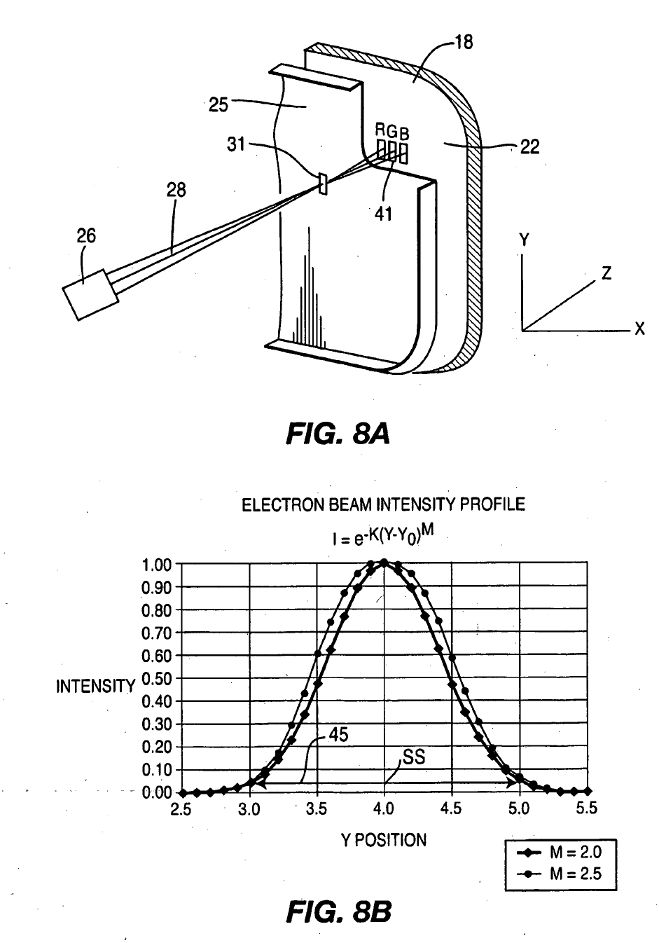

FIG. 2 shows a color cathode-ray tube (CRT) 10 according to the invention having a glass envelope 11 comprising a faceplate panel 12 and a funnel 15, where the funnel has tubular neck 14 connected thereto. The CRT further includes a multi-aperture color selection electrode, or mask 25 within the faceplate panel 12, in a predetermined spaced relation to the screen 22. The funnel 15 has an internal conductive coating (not shown) that is in contact with, and extends from, an anode button 16 to the neck 14. The faceplate panel 12 comprises a viewing faceplate 18 and a peripheral flange or sidewall 20 that is sealed to the funnel 15 by a glass frit 21. The panel 12 may have a three-color luminescent phosphor screen 22 that is carried on the inner surface of the viewing faceplate 18. The screen 22 may include a multiplicity of screen elements comprising red-emitting, green-emitting, and blue-emitting phosphor stripes R, G, and B, respectively, arranged in triads, each triad including a phosphor line of each of the three colors as shown in FIG. 8A. FIG. 8B shows the electron beam intensity profile 41, which is the vertical cross section of a single scan line as it would be on the screen if there were no shadow mask for it to propagate through. This cross section has a spot size SS at the 5% of peak intensity line 45. The R, G, B, phosphor stripes are generally printed with a vertical orientation, wherein each triad corresponds to an individual column 30 of mask apertures 31 on the mask 25. FIG. 3 shows an enlarged section of a mask. The screen further includes a light absorbing matrix that typically separates the phosphor lines. A thin conductive layer (not shown), preferably of aluminum, overlies the screen 22 and provides a means for applying a uniform first anode potential to the screen 22, as well as for reflecting light, emitted from the phosphor elements, through the faceplate 18.

The CRT 10 further includes an electron gun 26 in the neck and the CRT has an external magnetic deflection yoke 37 attached thereto over the funnel 15 next to the neck 14. The gun 26 is shown schematically by the dashed lines in FIG. 2 and is centrally mounted within the neck 14, and can be designed to generate and direct three inline electron beams 28, a center and two side or outer beams, along convergent paths through the mask 25 to the screen 22. The inline direction of the beams 28 is approximately normal to the plane of the paper. The external magnetic deflection yoke 37, in the neighborhood of the funnel-to-neck junction, is also shown in FIG. 2. When activated, the yoke 37 subjects the three electron beams 28 to magnetic fields that cause the electron beams 28 to scan a horizontal and vertical rectangular raster across the screen 22.

A feature of the invention is a cathode ray tube having a novel combination of electron beam size and shape, mask vertical repeat size, and vertical tie bar size to accommodate a variety of scan line modes such that no objectionable moiré is present at any of the variety of scan line modes. Calculations were performed which considered the interaction of the electron beam and the aperture mask in the vertical direction. Further the calculations took into account the electron beam size and shape, the aperture mask vertical repeat size, the tie bar size, and the scan line spacing. The calculations involved determining the percent of the beam intercepted by the tie bars 32 (and conversely the amount of beam transmitted) and averaging the transmission over a given number of vertical repeats. The various calculations included staggered tie bars 32 which are typically used in inline electron gun systems.

With the calculations, a vertical repeat pattern was simulated in the vertical direction with one-half of the distance for a single column of slits. The maximum visible beat pattern occurred when there was close to an integral number of vertical repeats for each scan line spacing (near zero beat condition). In this case, the tie bar interception for each scan line is nearly the same and as the phase between the tie bar locations and the scan lines shifts, the change in the amount of beam transmitted is nearly the same over a number of nearby scan lines maximizing the visibility to the eye. This was simulated by looking at scan line spacings that are integral multiples of 1, 2, and 3 of the vertical repeat and then finding the maximum and minimum electron beam transmission as a function of phase between the tie bars 32 and the scan lines. From this, a moiré transformation function (moiré MTF) was calculated using the following equation, wherein T(max) and T(min) correspond to electron beam transmission maxima and minima, respectively, in adjacent higher transmission mask bands HT and lesser transmission mask bands LT, integrated over multiple mask columns 30.

$$moiré MTF = \frac{T ( max ) - T ( min )}{T ( max ) + T ( min )}$$

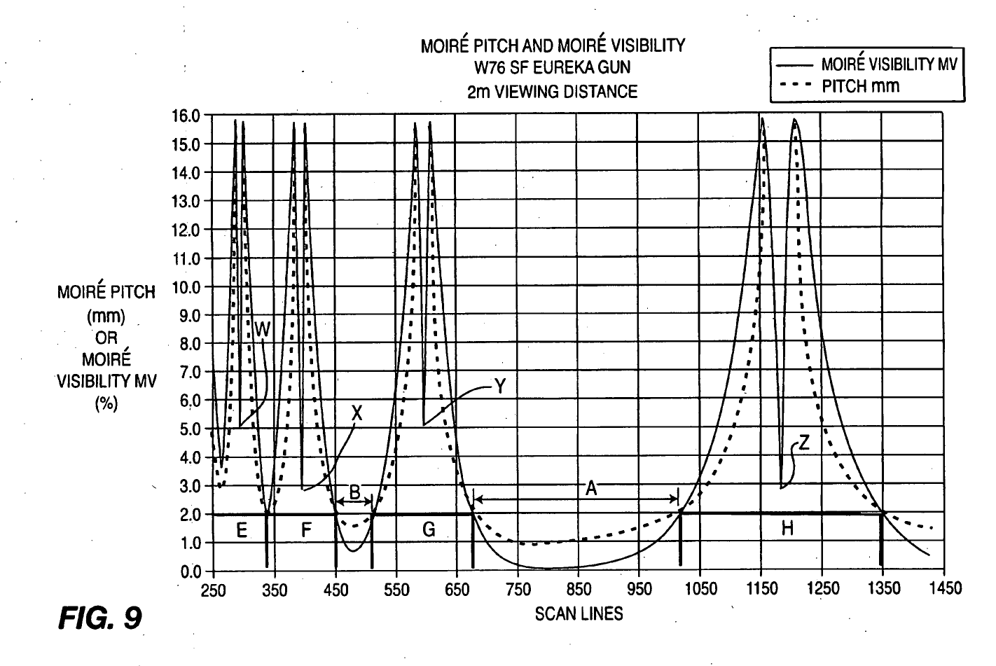

(T(max) and T(min) can also be considered localized light output, wherein the values can represent those which are integrated over at least 2 consecutive like said phosphor stripes.) The moiré MTF represents the maximum of the light to dark band contrast and is a function of the electron beam spot size and shape, the tie bar height w, the intra-column mask aperture pitch A_{V}, and the scan line spacing S_{L}. Moiré MTF is the same for scan line spacings that are 1, 2, or 3 times the vertical repeat. Moiré MTF becomes important when the moiré pitch is in a regime of human eye sensitivity. The peak sensitivity for humans is 34 cycles per degree of vision. In such a regime, increasing moiré MTFs will yield increasing visible moiré. The moiré MTF (×100%) is exhibited for the particular tube shown in FIG. 9 as the peak value of ˜15.5% (of the moiré visibility). This particular value of ˜15.5% represents the maximum observable moiré that can be sensed, which corresponds to those scan lines corresponding to the peak values of the moiré visibility MV in regions E, F, G, and H. The moiré visibility MV is determined from the contrast sensitivity of the human eye and the moiré MTF for a given system. (The human eye contrast sensitivity is described in a publication titled “Display Image Quality Evaluation” authored by Peter G. J. Barten at the SID Applications Seminar in Orlando, Fla. during May 23-25, 1995.) An object of this invention includes a CRT that has the capability of not exhibiting moiré even if the CRT were to be operating in a scan line mode that coincides with a moiré maximum such as in regions E, F, G, and H in FIG. 9. FIG. 9 shows the moiré visibility MV and moiré pitch P versus scan line spacing S_{L} for a specific tube design, where points W, X, Y, and Z are known as moiré zero beat conditions and locations A and B are known as moiré null locations. The moiré pitch is the dimension on the screen between the centers of two adjacent light bands. Point Z would correspond to the spacial relationship between the scan lines and mask transmission profile shown in FIG. 5. The zero beat condition is characterized as the mask transmission profile MTP and the electron beam intensity profile EBP being in phase having the same wavelength. FIG. 5 shows higher transmission bands HT, lesser transmission bands LT, and intra-column aperture pitch Aᵥ of the mask. The CRT here is operating in what is known as a moiré mode 1, wherein n=1. It should further be appreciated that similar moiré zero beat conditions will be experienced in this system in moiré mode 2 (n=2), moiré mode 3 (n=3), and so forth. The spacial relationship shown in FIG. 5, nor in any other zero beat conditions, is not an ideal condition in a conventional CRT. This becomes readily apparent in light of the moiré visibility curve in FIG. 9. This figure shows that operating at the points W, X, Y, and Z is precarious because only a slight deviation in scan line spacing dramatically increases the moiré visibility.

The moiré pitch P is derived from the following equation

$$P = \frac{{S}_{L} \times {A}_{V} / 2}{\vert {S}_{L} - n \times {A}_{V} / 2 \vert}$$

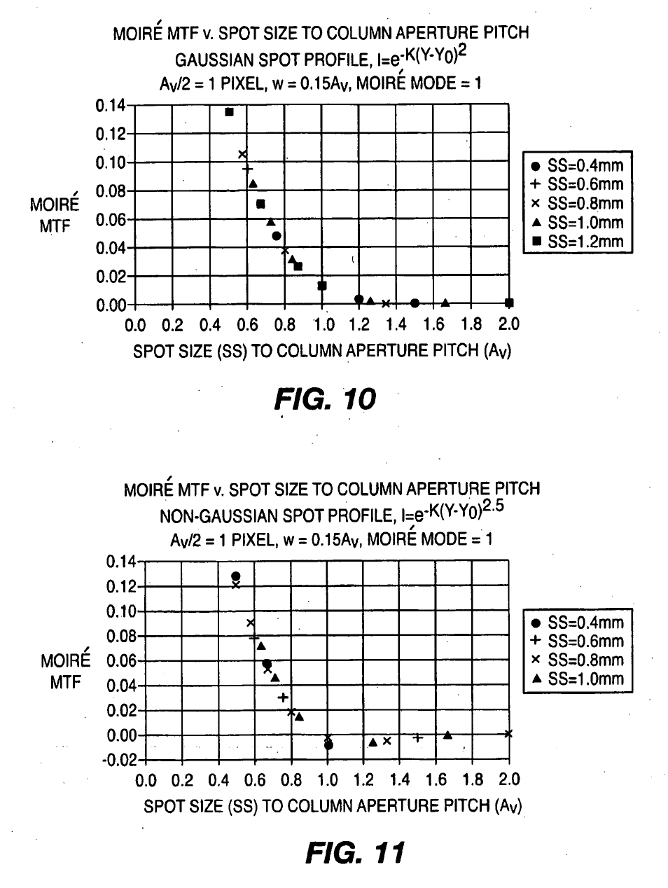

and is shown to be a function of the scan line spacing S_{L}, the intra-column aperture pitch A_{V} and the moiré mode n, which are integers. FIG. 9 shows a plot representing the moiré visibility MV versus scan line mode. Moiré visibility MV is a function of the moirétransformation function (moiré MTF) and the moiré pitch. The moiré visibility MV is a measure of detectability and it has been determined that the perceptibility threshold corresponds to those values that exceed about 2%. Thus, in these regions as moiré pitch approaches the maximum human visibility sensitivity correlating to 3-4 cycles for degree of vision, the moiré will be at it greatest detectability by the human observer. Further, as the moiré MTF decreasesd, the moiré visibility will decrease and consequently, the moiré will be less detectable. The simulation shown in FIG. 9 shows the greatest moiré visibility MV will be at about ˜15.5%, which turns out to be the moiré MTF value (×100%). The maximum moiré visibility MV is realized when the vertical repeat and scan line spacings are such that the tube operates near a zero beat condition, such as in regions E, F, G, and H in FIG. 9. From calculations, it turns out that the maximum moiré visibility is a function of the vertical repeat spacing to the spot size. This is plotted graphically in FIG. 10, where the profile I_{g} of the cross section of a scan line is a Gaussian shape, a tie bar web height w is 0.15 A_{V}, and the scan line spacing S_{L} is 0.5 A_{V}. The Gaussian function is expressed below.

I_{g}=e^{-k(y-y}^{₀}⁾^{²}

As shown in FIG. 10 (for the conditions set forth therein), the moiré MTF will be less than 0.02 as long as the ratio of the spot size (SS) to the vertical aperture pitch, A_{V}, is larger than 0.9. Simulations have shown that when spot size (SS) exceeds the vertical aperture pitch, A_{V}, for such beam shapes, the moiré MTF will be less than 0.02 for CRTs having any tie bar web heights.

FIG. 11 shows a similar plot for a non-Gaussian electron beam profile I_{ng} which is slightly rectangular and is expressed by the function below.

I_{ng}=e^{-k(y-y}^{₀}⁾^{^{2.5}}

As shown in FIG. 11, the moiré MTF will be less than 0.02 as long as the ratio of spot size (SS) to the vertical aperture pitch, A_{V} is larger than 0.9 for this particular CRT. The CRT exhibited in FIG. 11 has a tie bar web height w of 0.15 A_{V} and a scan line spacing S_{L} of 0.5 A_{V}. What has been further determined from simulations is that as long as the spot size to the vertical aperture pitch, A_{V}, is larger than the spot size SS, the moiré MTF will be less than 0.02 for CRTs having any tie bar web heights. As such, objectionable moiré is not observed even when operating in the maximum moiré mode regions E, F, G, H in FIG. 9.

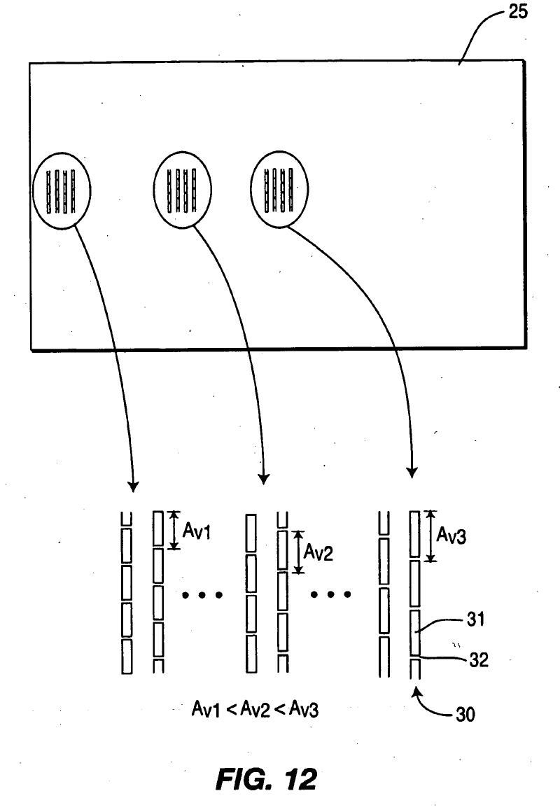

FIG. 12 shows one embodiment where the aperture pitch of the mask decreases with increasing distance from the central mask column. In other words, having the aperture pitch of the mask decrease near the edge of a screen with increasing distance from the central mask column is particularly beneficial because moiré tends to be more prevalent at the edge of a screen.

Other significant considerations in designing a CRT include the likelihood of the influence of self-convergence of the spot size of electron beams. In particular, the horizontal deflection field of self converging systems produces a lensing effect on the deflected beams that causes them to be overfocused in the vertical direction toward the 3:00 and 9:00 edges. As an example to confirm the invention, the vertical spot sizes for the green beam in a W97 CRT having an electron gun with a very small spot size was were measured and those values were as follows:

| | 0.2 mA of | 1.0 mA of |
|---|---|---|
| Screen Position | Beam Current | Beam Current |
| Center | 1.3 mm | 1.9 mm |
| 3 in. from 9:00 Edge | 0.5 mm | 1.0 mm |
| 0.8 in. from 9:00 Edge | 0.35 mm | 0.5 mm |

Observations on this tube with varying the scan height and the dynamic focus for maximum moiré show that the moiré at a beam current of 0.2 mA was very visible at 0.8 in. from 9:00 edge and just barely visible at 3 inches in from the screen edge. The vertical repeat for this tube was 0.55 mm. The application of the invention would have the intra-column aperture pitch be designed to not exceed 0.39 mm in the mask region within 0.8 in. of the 3:00 and 9:00 edges. At 1 mA, the moiré disappears at 0.8 inches from the screen edges when the vertical repeat for this tube was not greater than 0.55 mm. This agrees well with calculations which indicate that as long as the vertical spot size is larger than 0.9 A_{V}, moiré will not be significantly visible even in the maximum modes. As such, no moiré would be observed in these areas even if the CRT were operation a maximum moiré mode and very low current. Conversely, if the spot size exceeds 0.55 mm, there will be no moiré with the mask design in the example W97 CRT.

It should be appreciated that the teachings of this invention include mask designs that have at least portions of the mask where the apertures in adjacent mask columns are not in a staggered configuration. Further, the invention is intended to include CRTs operating with dynamic focus or static focus electron guns, and CRTs designed to have a vertical scanning configuration, wherein the electron guns are aligned vertically and the mask columns are substantially horizontal. Other features the invention are display devices (such as computer monitors and entertainment CRTs), wherein the moiré MTF is less then about 0.02 for at least two scan lines.

What is claimed is:

1. A cathode ray tube comprising:
envelope having a panel and funnel,
said panel including a sidewall portion and a faceplate portion, said faceplate portion having on its interior a luminescent screen, said screen having a plurality of substantially straight phosphor stripes;
said panel further including a mask contained therein, said mask having columns of apertures, said columns corresponding to respective said phosphor stripes, said columns including tie bars which separate said apertures from each other in said columns, said apertures in said columns having an aperture pitch;
said funnel having a neck at an end opposite of said panel, said neck containing therein an electron gun;
said gun emitting at least one electron beam which scans across said columns of said mask in a direction perpendicular to said stripes, portions of said electron beam propagate through said apertures and impinge corresponding said phosphor stripes, said electron beam scanning across said screen in a number of sweeps, said number of sweeps making up a full screen image defining a scan line mode, wherein adjacent sweeps each have scan line spacings, said electron beam having a spot size, said spot size varying as a function of location as said electron beam scans across said screen and said spot size being the full width of that portion of said electron beam that exceeds 5% of the peak electron beam intensity, said full width being in the dimension parallel to said columns of said mask; wherein
the ratio of said spot size of said electron beam to said aperture pitch exceeds about 0.9 and
said aperture pitch decreases with increasing distance from a central aperture column.

2. The CRT according to claim 1, wherein said gun is a dynamic focus electron gun or a static focus electron.

3. The CRT according to claim 1, wherein at least some of said apertures in said columns are staggered with respect to said apertures in said columns adjacent therewith.

4. The CRT according to claim 1, wherein said CRT operates at a number of said sweeps that are within the range of 250 to 2000.

5. The CRT according to claim 1, wherein said columns of said apertures are oriented vertically and said sweeps are scanned horizontally.

6. The CRT according to claim 1, wherein said columns of said apertures are oriented horizontally and said sweeps are scanned vertically.

7. The CRT according to claim 1, wherein said screen has a moiré transformation function of less than about 0.02, said moiré transformation function being a quotient having a numerator being the difference between a light output maximum value and a light output minimum value and a denominator being the sum of said light output maximum value and said light output minimum value; wherein
light output is the quantitative measure of light generated as said at least one electron beam scans said screen;
said maximum value is the greatest value of said light output which is integrated over at least 2 consecutive like said phosphor stripes; and
said minimum value is the lowest value of said light output which is integrated over at least 2 consecutive like said phosphor stripes.

8. The CRT according to claim 1, wherein said electron beam has a spot shape in the axis parallel to said columns described as
I=e^{-k(y-y}^{₀}⁾^{^{m}}
wherein I is the electron beam intensity, k is a constant, y₀ is the position of the peak electron beam intensity for a single scan line, y-y₀ is the dimension from the peak electron beam intensity value, and m is a value in the range of 2.0 to 2.5.

9. A display device comprising:
envelope having a panel and funnel
said panel including a faceplate portion, said faceplate portion having a luminescent screen, said screen having a plurality of phosphor elements, each of said phosphor elements forming substantially a column,
said panel further including a mask contained therein, said mask having apertures which form substantially straight aperture columns, each of said apertures corresponding to a respective phosphor element, said apertures in each of said aperture column being separated by unetched metal, said apertures in said aperture columns having an aperture pitch;
said funnel having a neck at an end opposite of said panel, said neck containing therein an electron gun;
said gun emitting at least one electron beam which scans across said aperture columns, portions of said electron beam propagate through said apertures and impinge corresponding said phosphor elements, said electron beam scanning across said screen in a number of sweeps, said number of sweeps making up-a full screen image being a scan line mode, wherein spacially adjacent sweeps each have a scan line spacing, said electron beam having a spot size, said spot size being a dimension of said electron beam at 5% of the peak electron beam intensity, said dimension being parallel to said aperture columns, said spot size to said pitch having a ratio exceeding a value of about 0.9 along at least two of said sweeps.

10. The display device according to claim 9, wherein said ratio exceeds 0.9 throughout said screen.

11. The display device according to claim 9, wherein the aperture pitch decreases with increasing distance from a central aperture column in at least one lateral portion across said screen.

12. The display device according to claim 9, wherein said device is an entertainment cathode-ray tube or a computer monitor.

13. The display device according to claim 9, wherein said gun is a static focus gun or a dynamic focus gun.

14. The display device according to claim 9, wherein said device has a number of sweeps that are within the range of 250 to 2000.

15. The display device according to claim 9, wherein said aperture columns are oriented vertically and said sweep are scanned horizontally.

16. The display device according to claim 9, wherein said aperture columns are oriented horizontally and said sweeps are scanned vertically.

17. The display device according to claim 9, wherein said screen has a moiré transformation function of less than about 0.02, said moiré transformation function being a quotient having a numerator being the difference between a light output maximum value and a light output minimum value and a denominator being the sum of said light output maximum value and said light output minimum value; wherein
light output is the quantitative measure of light generated as said at least one electron beam scans said screen;
said maximum value is the greatest value of said light output integrated over multiple adjacent said straight aperture columns; and
said minimum value is the lowest value of said light output integrated over multiple adjacent said straight aperture columns.

18. The CRT according to claim 17, wherein said device has a number of sweeps that are within the range of 250 to 2000.

19. A cathode ray tube comprising envelope having a panel and funnel, said funnel having a neck at an end opposite of said panel, said neck containing therein an electron gun, said gun emitting at least one electron beam, said panel including a faceplate portion having a luminescent screen with a plurality of substantially straight phosphor columns, said panel having a mask contained therein, said mask having columns of apertures, said columns corresponding to respective said phosphor stripes, said columns including tie bars which separate adjacent apertures, said adjacent apertures having an aperture pitch, said aperture pitch in at least one portion of said mask decreasing with increasing distance from a central column of apertures and the ratio of said spot size of said at least one electron beam to said aperture pitch in said at least one portion of said mask exceeds about 0.9, said spot size being, a dimension that is parallel to said phosphor columns and being the full width at 5% of the greatest intensity of said electron beam.

20. The CRT according to claim 19, wherein said spot size to said pitch having a ratio exceeding a value of about 0.9 along at least two of said sweeps.

21. The CRT according to claim 19, wherein said spot size to said pitch having a ratio exceeding a value of about 0.9 over entire screen.

22. The CRT according to claim 19, wherein said screen has a moiré transformation function of less than about 0.02, said moiré transformation function being a quotient having a numerator being the difference between a maximum value and a minimum value of mask transmission and a denominator being the sum of said maximum and said minimum values; wherein
mask transmission being the percentage of said at least one electron beam that propagates through said apertures averaged over a plurality of adjacent said mask aperture columns; and
the regions containing said maximum and minimum values being adjacent to each other.

23. The CRT according to claim 19, wherein said spot shape in the axis parallel to said columns is described as
I=e^{-k(y-y}^{₀}⁾^{ⁿ}
wherein k is a constant, y₀ is the position of the peak electron beam intensity for a single scan line, y-y₀ is the dimension from the peak electron beam intensity value, and m is a value in the range of 2.0 to 2.5.

24. The CRT having envelop including a panel attached to a funnel, said funnel having a neck and an electron gun for generating at least one electron beams contained in said neck, and a mask contained in said envelop near said panel, comprising:
a region in said mask having columns of apertures of predetermined heights and predetermined pitches; and
said at least one electron beam having a spot size range and spot shape selected such that the moiré transformation function for said CRT in said region is less than about 0.02, wherein, said moiré transformation function being a quotient having a numerator being the difference between a maximum value and a minimum value of mask transmission and a denominator being the sum of said maximum and said minimum values; wherein
mask transmission is the percentage of electrons of a uniform electron beam incident on said that can propagate therethrough said apertures averaged over a plurality of adjacent said mask aperture columns and said regions containing said maximum and minimum values are adjacent to each other.
